(19) United States
(12) Patent Application Publication
(10) Pub. No.: US 2015/0254741 A1
(43) Pub. Date: Sep. 10, 2015

(54) COMPUTER BASED PROCUREMENT SYSTEM AND METHOD

(71) Applicants: SACHIN SHARMA, MUMBAI (IN); PRASAD GUPTE, MUMBAI (IN)

(72) Inventors: SACHIN SHARMA, MUMBAI (IN); PRASAD GUPTE, MUMBAI (IN)

(21) Appl. No.: 14/721,369

(22) Filed: May 26, 2015

Related U.S. Application Data
(63) Continuation-in-part of application No. 13/315,281, filed on Dec. 8, 2011, now abandoned.

(30) Foreign Application Priority Data
Oct. 11, 2011 (IN) 2868/MUM/2011

(51) Int. Cl. G06Q 30/06; G06Q 20/40

(52) U.S. Cl. CPC G06Q 30/0603; G06Q 20/405

(57) ABSTRACT

Computer based procurement systems and methods are described. The systems and methods include receiving search input for an item to be purchased and searching one or more electronic catalogs to identify at least one item in the one more catalogs that relates to the search input. The systems and methods also include determining a uniform taxonomy code (UTC) associated with the at least one item and accessing one or more pre-configured purchasing control rules associated with the UTC. Moreover, the systems and methods include performing actions associated with purchase order generation based at least upon the one or more pre-configured purchasing control rules.

### CROSS-REFERENCES TO RELATED APPLICATIONS

The instant application is a continuation-in-part of U.S. patent application Ser. No. 13/315,281, filed Dec. 8, 2011, pending, and claims priority to Indian Patent Application Ser. No. 2868/MUM/2011, filed Oct. 11, 2011, the entire specifications of both of which are expressly incorporated herein by reference.

### FIELD OF THE INVENTION

The present invention is generally related to techniques for the procurement of materials and services in organizations. More specifically, the present invention provides new and improved computer based procurement systems and methods for the procurement of materials and services in organizations.

### BACKGROUND OF THE INVENTION

The procurement function in an organization often purchases various types of goods and services. These goods and services may be offered by different vendors. These vendors typically provide catalogs specifying their offerings. It is desirable for the procurement function to be able to peruse various catalogs before making the purchasing decision. It is also desirable for the organizations to be able to ensure that certain policies and/or best practices are adhered to when the purchasing decisions are made. However, conventional procurement systems and methods are not able to adequately ensure that certain policies and/or best practices are adhered to when the purchasing decisions are made.

Accordingly, there exists a need for new and improved systems and methods to facilitate the procurement of goods and services that overcome the afore-mentioned disadvantages.

### SUMMARY OF THE INVENTION

It is an object of the present invention to provide a computer based procurement system and method. The techniques according to the present invention advantageously facilitate importing electronic catalogs in the computer system and associating UTCs (uniform taxonomy codes) with the goods/services included in the catalogs. The invention facilitates configuration of one or more purchasing controls with any of the UTCs. These controls may be enforced at the time stored catalogs are searched and/or at the time purchase orders are created for the UTC. Moreover, the present invention also permits searching web based online catalogs. Preferably, the matching item found in the online catalog search is mapped to UTC and the purchasing controls configured for the UTC may be enforced when purchase orders are created or sought to be created.

In accordance with the general teachings of the present invention, a computer based system for procurement is provided. The system comprises a processor unit. Moreover, the system comprises a computer readable medium storing instructions. The instructions are executable by the processor unit to perform the steps of receiving search input for item to be purchased and searching one or more electronic catalogs to identify at least one item in the one more catalogs that relates to the search input. The instructions are also executable by the processor to perform the steps of determining a uniform taxonomy code (UTC) associated with the at least one item and accessing one or more pre-configured purchasing control rules associated with the UTC. Moreover, the instructions are executable to perform action associated with purchase order generation based at least upon the one or more pre-configured purchasing control rules. In alternative embodiment, method for computer based procurement is provided.

In accordance with one embodiment of the present invention, a computer based procurement system is provided, comprising:

a host computer;

a processor unit operably associated with the host computer;

a communication interface selectively operable to access the host computer from a plurality of remote input/output devices so as to manage an element of the procurement system; and

a computer readable medium storing instructions executable by the processor unit to perform the steps of:

receiving a search input for an item to be purchased, wherein the search input is in free form text;

searching one or more electronic catalogs to identify at least one item in the one more catalogs that relates to the search input;

determining a uniform taxonomy code (UTC) associated with the at least one item;

accessing one or more pre-configured purchasing control rules associated with the UTC;

performing an action associated with a purchase order generation based at least upon the one or more pre-configured purchasing control rules; and

searching the one or more electronic catalogs includes matching at least one text term in the search input with a textual description of the items in the one or more electronic catalogs.

In accordance with another embodiment of the present invention, a computer based procurement method, comprising the steps of:

providing a host computer;

providing a processor unit operably associated with the host computer;

providing a communication interface selectively operable to access the host computer from a plurality of remote input/output devices so as to manage an element of the procurement system;

providing a computer readable medium storing instructions executable by the processor unit to perform the steps of:

receiving search input for item to be purchased, wherein the search input is in free form text;

searching one or more electronic catalogs to identify at least one item in the one more catalogs that relates to the search input;

determining a uniform taxonomy code (UTC) associated with the at least one item;

accessing one or more pre-configured purchasing control rules associated with the UTC;

performing an action associated with purchase order generation based at least upon the one or more pre-configured purchasing control rules; and

searching the one or more electronic catalogs includes matching at least one text term in the search input with a textual description of the items in the one or more electronic catalogs.

For example, the user could manage an element of the procurement system on the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

FIG. 1 illustrates an exemplary computer network environment appropriate for a specific embodiment of the present invention;

FIG. 2 illustrates an exemplary computer apparatus that may provide a computing platform to practice specific embodiments of the present invention;

FIG. 3 illustrates an exemplary schematic of a procurement system according to a specific embodiment of the present invention;

FIG. 4 illustrates an exemplary flow of steps in a procurement method according to a specific embodiment of the present invention; and

FIG. 4A illustrates an exemplary flow of steps for importing computer readable catalogs for products/services, according to a specific embodiment of the present invention.

### DETAILED DESCRIPTION OF THE INVENTION

The following detailed description of the invention refers at various places to the accompanying drawings and specific environments, applications, platforms, examples, computer screenshots, and implementations. The detailed description is provided for thorough understanding of the present invention and is illustrative rather than limiting.

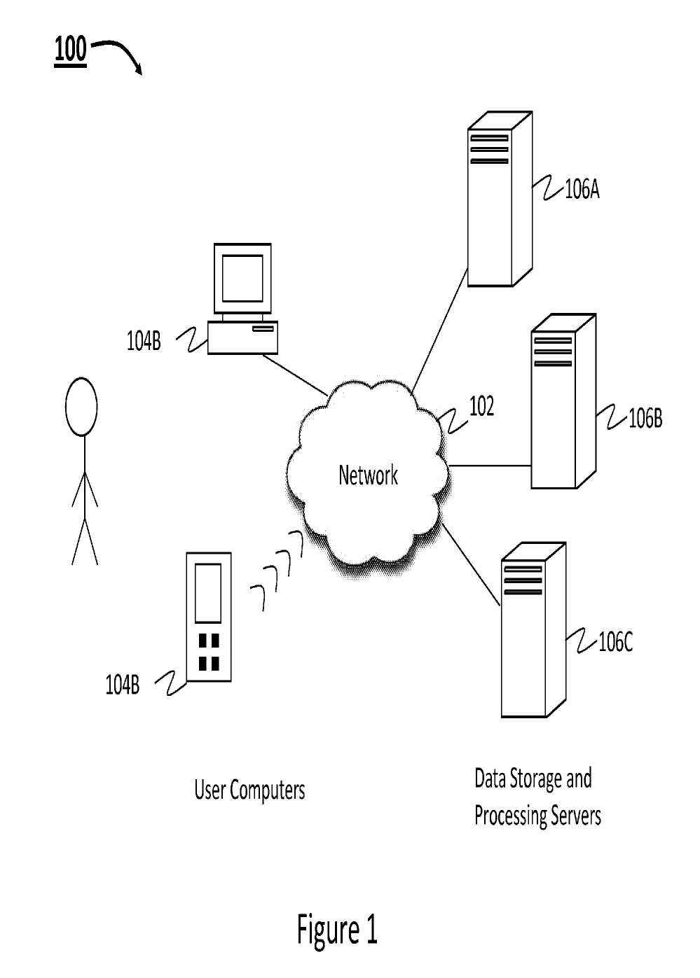

FIG. 1 illustrates an exemplary networked computer system 100 which may provide an environment to practice certain specific embodiments of the present invention. As shown in FIG. 1, multiple end user computer systems 104 and multiple server computer systems 106 may be coupled to a computer network 102. For example, the computer network 102 can be a private network of the organization. In alternative embodiment, the computer network 102 may include the local area network (LAN); and in yet an alternative embodiment it may include the Internet. The end user computer systems 104 may include without limitation desktop computers, laptop computers, personal digital assistant (PDAs), tablets, and smart phones. The computer systems 104, 106 etc. may exchange information using the computer network 102.

The servers 106 store digitized content which may be accessed (e.g., read, downloaded, searched, changed etc. as appropriate) over the computer network. A specific portion of the content is often identified using a hyperlink. The content stored in one server may also be accessed by another server and by the end user computer system. Popular techniques for accessing the content include HTTP and (HyperText Transfer Protocol) and HTTPS (HyperText Transfer Protocol Secure), though other techniques may also be used. Access to some portions of the content may require authentication and/or authorization for access.

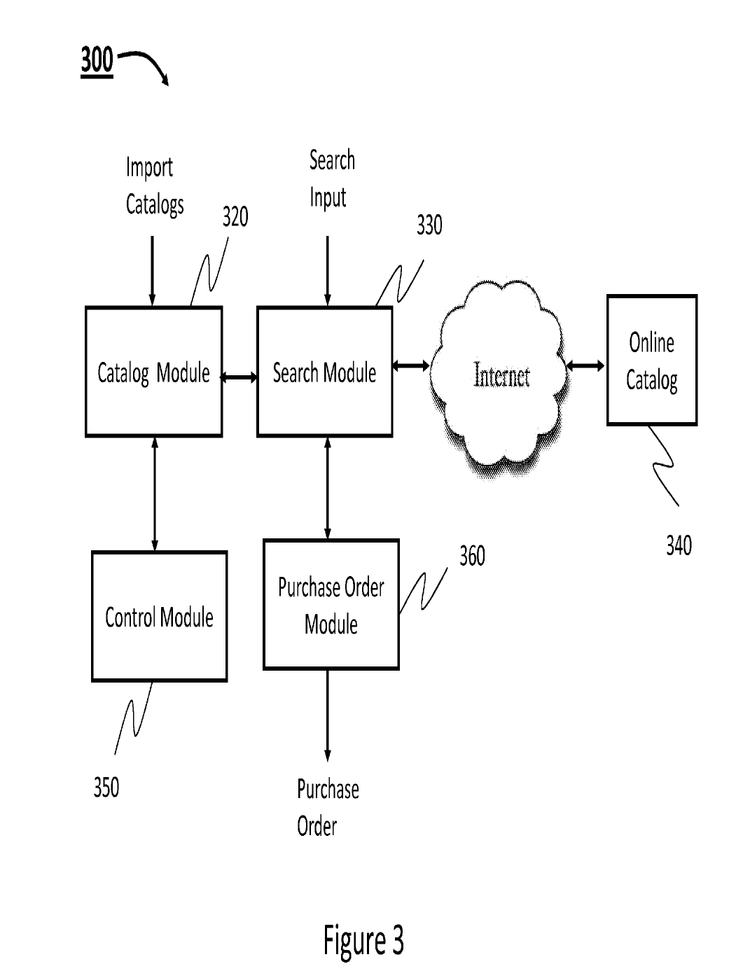

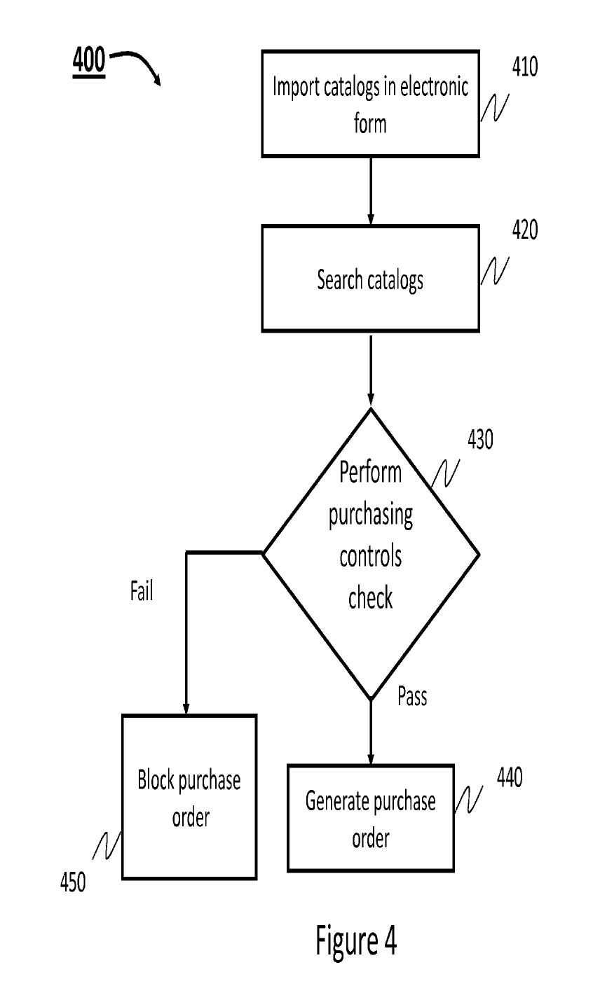

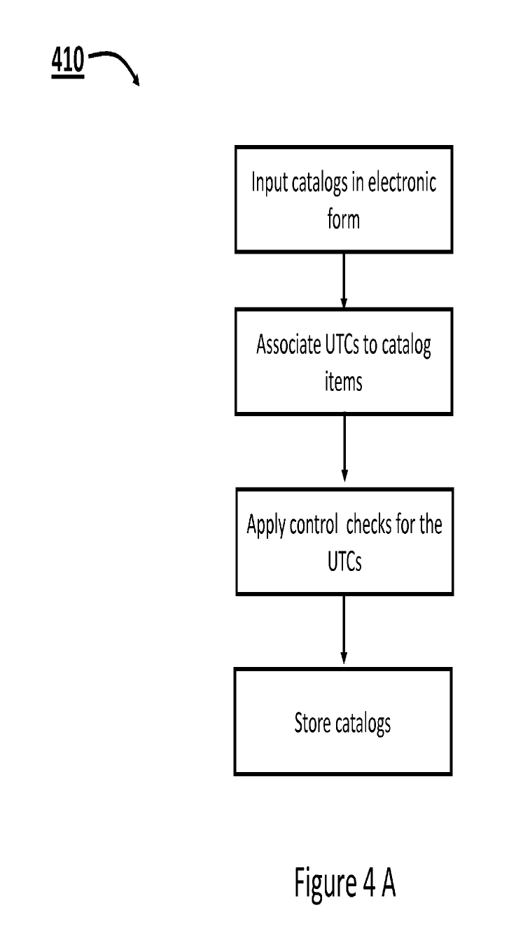

Depending upon embodiments of the present invention, the servers 106 and the computer systems 104 may be configured to perform certain acts. For example, the servers 106 and the computer systems 104 may include software which can facilitate performing these acts. These acts can include various acts performed by the various modules illustrated in FIG. 3. Moreover, these acts may include various acts performed by during the process illustrated in FIG. 4.

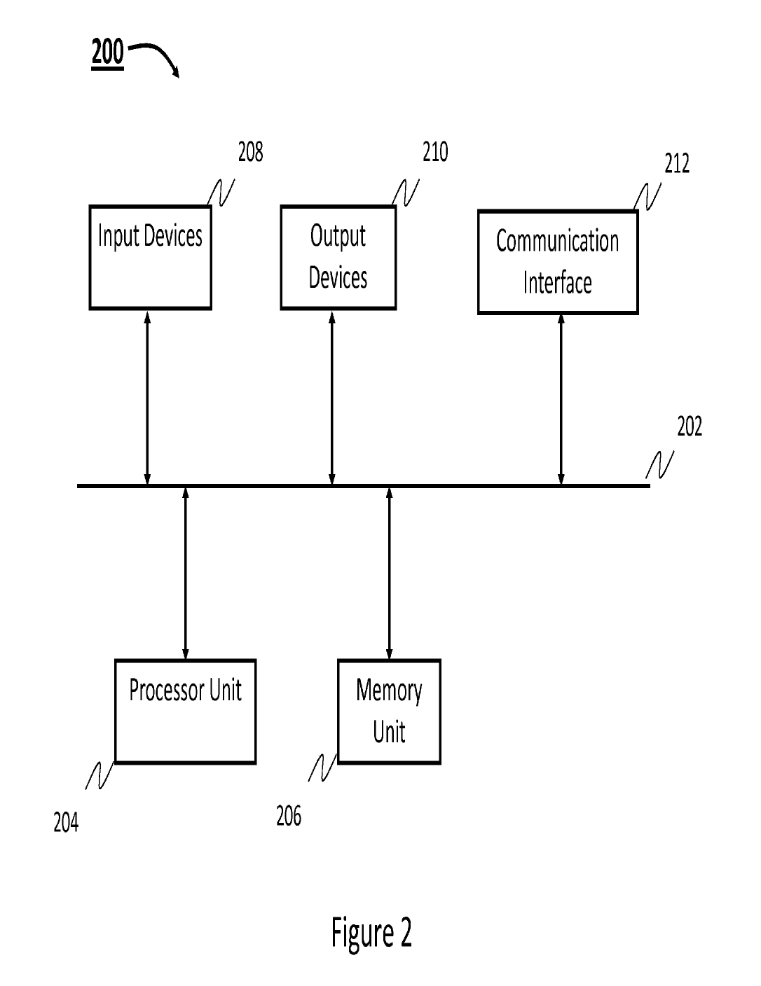

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors etc. The processor unit may interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables communication with other devices and systems via a network. For example, the communication interface may include Ethernet interface, optical network interface, wireless interface etc.

FIG. 3 illustrates an exemplary schematic 300 of a procurement system according to an embodiment of the present invention. As shown in FIG. 3, the system 300 comprises various modules. Each of these modules may be a hardware module, a software module, or combination thereof. Moreover, depending upon the embodiment, each of the modules may reside on a single computer system or may be distributed across a plurality of interconnected computers. The user interaction module (not shown) provides interface between user and machine, and performs acts such as receiving input from user and providing output to the user. The catalog module 320 may store catalogs from one or more vendors in electronic form. The search module 330 may perform searching for desired items based upon the search input provided by the user. The search module may perform searching on the information stored in the catalog module 320 and/or in online catalogs 340. The control module 350 may enforce certain purchasing controls at the time catalog data may be received in the catalog module and/or at the time search may performed and/or at the time purchase order may be generated. The purchase order generation module 360 may facilitate creation and submission of purchase orders.

An exemplary flowchart 400 illustrating certain steps in a computer based procurement process according to a specific embodiment of the present invention is shown in FIG. 4. As shown in FIG. 4, the process may permit inputting of goods/services catalogs in a computer system (step 410). Preferably, the catalogs to be inputted are in computer readable form. Moreover, according to certain embodiments of the present invention, the catalogs so inputted are stored in the computer system along with the UTCs (uniform taxonomy codes) for goods/services in the catalog. More specifically, the process according the present invention facilitates using pre-configured rules to match specific goods/services in the catalogs to the UTCs.

Taxonomy refers to classification, which may include multiple taxonomy codes in a flat or hierarchical structure. For example, flat taxonomy may include classification such as manufacturing and construction, transportation and logistics, services, information technology and telecommunication, agriculture, chemicals, etc. As another example, hierarchical taxonomy may include hierarchical classification. For example, the category information technology (code: 43000000) can include subcategory for communication devices (code: 43190000), which may include further subcategory for personal communication devices (code: 43191500), which may include mobile phone (code: 43191501), pager (code: 43191502), etc.

According the present invention UTCs may be used from standard taxonomies such as, for example, UNSPSC (United Nations Standard Products and Services Code), NAICS (North American Industry Classification System), etc. Alternatively industry specific UTCs may be used. Yet alternatively, proprietary UTCs may also be used.

Moreover, in specific embodiments, the process also facilitates enforcing certain pre-configured controls on the catalogs that are inputted (as illustrated in FIG. 4A by exemplary flow of steps (410) for importing the catalogs). For example, UTC of the product/service may be used to identify the controls to be enforced on specific catalog or specific product/service in the catalog. More specifically, certain controls may be pre-configured in the system for a specific UTC. Examples of the controls include allowing/disallowing inputting of certain goods/services based upon vendor identity, list price criteria, quality criteria, favoring one vendor over another, etc. For example, an electronic catalog received from DELL may be permitted to be used for the taxonomy codes of Notebook Computers (43211503) and Desktop computers (43211507), but not permitted for the taxonomy code for ‘Computer Servers’ (43211501).

In a specific embodiment, the process permits marking certain items in the catalogs as approved/unapproved based on one of the above and/or other criteria. In an alternative specific embodiment, the process permits blocking the importing of the items that are not approved. In further alternative specific embodiments, the process permits associating certain attributes with items in the imported catalogs. Examples of the attributes include “favored vendor”, “incumbent vendor”, “contracted vendor”, etc. Additional examples include, “price above threshold”, “quality below threshold”, “shipping cost above/below threshold”, etc.

At step 420, the process permits free form search queries on the catalogs that are inputted. For example, the keywords from the query are matched with goods/services descriptions in the catalogs to fetch matching items.

Based on the UTCs for the matching items, the process permits checks to enforce controls (step 430) configured with the UTCs. More specifically, certain controls may be pre-configured in the system for a specific UTC. Examples of the controls include favoring one vendor over another, ensuring compliance with the contract negotiated with vendor, etc.

If the controls check passes, the process permits automatic retrieval of the computer based purchase order template. The user may then fill the purchase order template and submit it for requisition (step 440). On the other hand, if the controls check does not pass on certain item, the purchase order generation for that item may be blocked (step 450).

In specific embodiment, in addition to or instead of searching catalog data, the process also permits searching web based online catalogs at step 420. The matching item found during the online catalog search may be mapped to UTC and the controls check configured with the UTC is performed on the item. If the controls check does not pass, the user may not be permitted to issue purchase order on that item. On the other hand if the control check passes, the process permits (as in step 440) automatic retrieval of the computer based purchase order template. The user may then fill the purchase order template and submit it for requisition. As merely an example to illustrate this embodiment, consider that the control may be configured to use electronic catalog hosted by the vendor “STAPLES” for use with taxonomy code for ‘Office Equipment and Accessories and Supplies’ (Code: 44000000) and its child categories (i.e., all other taxonomy codes that begin with 44). Suppose the user searches for and returns from the “STAPLES” online catalog with a “DELL XPS 14” laptop in shopping cart. Then, this embodiment may block the purchase, because the use of the “STAPLES” online catalog is not allowed for the taxonomy code 43211503 corresponding to notebook computers.

In certain embodiments, certain controls may be applied after the item is submitted for requisition (e.g., as in step 440). Alternatively or in addition, certain controls may be applied before step 440 before raising purchase order. Certain illustrative examples of such controls are described below:

Category experts: Category experts may be associated to certain UTCs. In this example, approval of such expert may be required before item may be purchased. For example, Bob could have knowledge of hydraulic pumps. So, when hydraulic pumps are to be purchased, depending on configuration, the workflow may automatically include Bob for approval, because he is a category expert who is associated to the taxonomy code ‘40151533’ for “Hydraulic Pumps.” Alternatively, UTCs may also be mapped to user groups in the system, or specific roles or designations for approval.

Internal buyers: As another example, Alice could be knowledgeable about items belonging to the parent UTC 43000000 for ‘Information technology and telecommunication’. Thus, purchase requests/requisitions that contain items belonging to 43000000 and its child UTCs (e.g., notebook computers—43211503, keyboards—43211706, etc.), may be automatically routed for purchase to Alice. Alternatively, UTCs may also be mapped to user groups in the system, or specific roles or designations for approval for purchasing.

Supplier: A supplier may be tagged to the uniform taxonomy code to indicate the products and services provided by the said supplier. Also, one or more suppliers can be marked as a preferred supplier for a taxonomy code. When an order is being placed, the system may check to see if the supplier supplies items belonging to a taxonomy code, and whether the supplier is preferred for that code. For example, consider three suppliers tagged to the uniform taxonomy code as follows: DELL for notebook computers (43211503, preferred), desktop computers (43211507, preferred); LAFARGE for cement (30111601, not preferred); and CEMEX for cement (30111601, preferred). When an order is being placed for an item that belongs to the taxonomy code 30111601 of “Cement,” the system may alert the user that although LAFARGE is tagged to “Cement,” it is not preferred, and a preferred supplier (CEMEX) already exists. If DELL is selected, the system may alert the user that DELL does not provide cement, and may block the purchase based on configuration.

Contract: A contract with the supplier may also be associated with the universal taxonomy codes. Moreover, specific discounts for each taxonomy code may be specified. When a contract number is being mentioned on a purchase order, the system may check to see if items being purchased are allowed as per the contract. The system may also determine savings from the contract for each specific taxonomy code. For example, suppose that contract #123 with DELL exists for notebook computers 43211503 (5% discount) and desktop computers 43211507 (7% discount). If a purchase order is created for DELL Computers for “servers,” and contract #123 is mentioned, the system may inform the user that purchase of servers is not covered under this contract. On the other hand, if the laptop DELL Inspiron 445 is being purchased, the system may compute the savings based on the discount percentage configured with the taxonomy code (5%).

Budgets: Budgets may also be associated to the universal taxonomy code. When a purchase cost is being booked to a budget, the system may check if the item is allowed to be purchased on that budget. For example, the F&A budget within an organization may be used for items (products/services) such as accounting services (84111500), tax advisory services (84111802), audit services (84111600). When purchase costs for “prepared and preserved foods” (50190000) are booked to the F&A budget, the system may alert the user that such a purchase is not allowed on that said budget.

By way of a non-limiting example, the user may use a mobile handheld device to make a free text search for the item that he needs to purchase. The user may be provided with a web form to provide free text for the item to be searched. The system may include two level checks: (1) pre-control checks before uploading catalogs into the catalog system; and/or (2) purchase control checks before raising the purchase order.

With respect to pre-control checks before uploading catalogs into the catalog system, every electronic catalog in the system may be tagged to a plurality of taxonomy codes. When the catalog is being stored with uniform taxonomy codes, the system may check to see if an item does not belong to one of the tagged taxonomy codes, and alert the user accordingly. This is pre-order purchase control, which may make sense for internal catalogs, which are catalogs within the database.

For example, if a catalog is received from DELL and is tagged to be used with the taxonomy codes of notebook computers and desktop computers. During storage, if the system finds an item belonging to the taxonomy code “servers,” then the system may alert the user to take necessary action.

With respect to the purchase blocking aspect for “punchouts” (punchout is a term generally defined as an external electronic catalog that is hosted by the supplier, which may be accessed by users on the buyer side from another application (i.e., “calling application”) to view and add items to the cart, and return to the calling application with the information about items in the shopping cart), the system may tag punchouts to the uniform taxonomy code, so that when the user returns to the application with items in the shopping cart, their descriptions may be normalized to the taxonomy codes, which in turn may be checked against the allowed taxonomy codes.

For example, consider the punchout hosted by the supplier “REYNOLDS” that is configured for use with the taxonomy code “Office Stationery.” When the user returns from the REYNOLDS punchout with a laptop or any other item sold by REYNOLDSs other than office stationary, the system may block its purchase, because the use of the REYNOLDS punchout is not allowed for the taxonomy code corresponding to laptops or any other items other than office stationary.

With respect to the purchase control checks before the raising of the purchase order, there may be category experts tagged to the uniform taxonomy code of the item whose approval is required on specifications for a certain category. For example, “Bob” could have vast experience in the design of hydraulic pumps. So, whenever hydraulic pumps are to be purchased, depending on configuration, the workflow may automatically include Bob for approval, because he is a category expert and accordingly tagged to the taxonomy code of that item.

Internal buyers from the procurement department may also be tagged to the uniform taxonomy to configure the specific areas of purchase. For example, “Alice” might be specialized to buy IT supplies, and may be tagged to all taxonomy codes related to IT supplies. Thus, any purchase requests (e.g., requisitions) that contain items belong to an IT supplies category (e.g., notebook computers, mice, etc.), may be automatically routed for purchase to Alice.

A supplier may be tagged to the uniform taxonomy code to indicate the products and services provided by the supplier. Also, a supplier may be marked as a preferred supplier for a taxonomy code. When an order is being placed, the system may check to see if the supplier supplies items belonging to a taxonomy code, and whether the supplier is preferred for that code. This feature is very important when free-text i.e., (non-catalog) items are being purchased. For example, consider that the system has three suppliers (from the supplier repository) tagged to the uniform taxonomy code as follows: DELL>notebook computers (preferred), desktop computers (preferred); LAFARGE>cement (not preferred); and CEMEX>cement (preferred). When an order is being placed for an item that belongs to the taxonomy code of “cement,” if DELL is selected, the system may alert the user that DELL does not provide cement, and may block the purchase based on configuration. If LAFARGE is selected, the system may alert the user that although LAFARGE is tagged to “cement,” it is not preferred, and a preferred supplier (CEMEX) already exists.

With respect to value and volume control checks, a particular limit of the quantity and value may be configured.

The above control rules may also be configured by the user.

The control rules configured by the user may be validated by the contract terms for that item and the budget. If there are any conflicting terms between the control rules and the contractual terms and the amount under budget, then the system may provide approval alerts to the preconfigured approving authority. The approval may be triggered based on the item, its category business unit and/or the amount/value of purchase. Thus the flow would be:

Free text search—mapping to search catalogs—the item(s) fetched by the search—are mapped to purchase control rules—the purchase control rules are validated against the contract module—the value of the purchase may be validated against the budget module—conflict(s) between the purchase control rules with contract module or budget may be sent for approval.

With respect to the steps for validating purchase/procurement rules with the contract module(s) to check conflicting terms, the e-procurement may be integrated to the contract management module, for any item fetched through the search module of the e-procurement may be mapped to the contract in the contract management module.

Suppose a procurement rule has been configured stating that HP laptops in the quantity of 100 may be ordered by user x from business unit of the company. So when user x orders 80 HP laptops, this may be validated by the contract module to check the contract of HP and ascertain whether it is within limit of the contract, and if not, it may provide a conflicting note for approval.

Contract management may contain contracts. The following is a description that describes in detail how the relevant clauses may be extracted from the contract for validating the purchase control rules.

Before storing any e-contract into the contract management system, a metadata form may be required to be filled out/in.

Before uploading a large number of odd contracts into the contract management tool, on an EXCEL sheet, certain common fields may be mentioned against those common fields contract information may be provided by reading each contract. The relevant information related to the e-contract may be captured on the EXCEL sheet within the software tool that helps in contract creation or searching a contract in a contract software tool. So, a basic EXCEL sheet may provide some common fields that are enumerated to capture common information present in the contracts, wherein the common fields may be provided according to the needs of the user. For example, common fields such as those shown in the TABLE below may be used:

TABLE

LIST OF FIELDS
CONTRACT CATEGORY, e.g., vendor
CONTRACT ID
CONTRACT SUB CATEGORY, e.g., administration,
marketing communications, human resources
CONTRACT TITLE
DATE OF CONTRACT
PRODUCT TYPE
QUANTITY/VOLUME
DISCOUNT AMOUNT/RATE OF DISCOUNT
SUPPLIER NAME
VALUE OF CONTRACT
CONTRACT NUMBER
CONTRACT STATUS
START DATE, EXPIRY DATE, RENEWAL
SUPPLIER NAME
PAYMENT TERMS
TOTAL VALUE
STAKE HOLDER INFORMATION
CONTRACT CONTACT PERSON
SIGNING AUTHORITY

Before uploading a large number of odd contracts into the contract management, once the above information is provided on the EXCEL sheet for all the contracts, all the relevant external contracts may then be uploaded. Once the external contracts are uploaded into the contract management tool, there is an option for the user to click extract payment terms/discount related clauses, or any other specific clause or all clauses of the contract.

With respect to the extraction of clauses, the received external contract document typically comprises a plurality of clauses arranged in flowing paragraphs spanning multiple pages. The clauses may include contractual terms, payment terms, references to other documents, etc. In one embodiment, the clauses may be organized into sections and titles for improved readability. Exemplary sections and titles include contract title, section title, clause title, and clause text. In alternative embodiments, there may not be such organization and the clauses may be free flowing.

The method of the present invention may process the received contract document in order to extract the clauses, sections and titles from it. In one embodiment of the present invention, the information extraction module may perform this extraction task. For the purpose of information extraction, the present invention may utilize certain heuristics. The heuristics may be pre-configured in the system. Users may also provide their own heuristics or alter the pre-configured heuristics to suit the particular contract document.

An exemplary technique for information extraction is described below. For more effective processing, the system may log various text string patterns that were manually reclassified by the end user, based on which the system may generate new or modified versions of the existing heuristics (assumptions). The system administrator may have the ability to review these new or modified heuristics and assign a confidence value to each. By way of a non-limiting example: the smallest unit of the contract may be a clause; one or more clauses may have clause titles; clauses may or may not be grouped into sections; the section may have a title; a contract as a whole may have a title; clauses, clause titles, section titles, and contract title may be distinguished on the basis of font style wherein the font style may comprise one or more of font face, font family, font size, and font texture (bold, underlined, italics, etc.); the text style that is found most frequently may be considered as clause text; the text style that is found to precede the clause text most frequently may be considered as the clause title; if there is no specific text style preceding the clause text, check if the clause title is a group of words in capital case at beginning of the clause text; if clause title is found, then the text style that is found to precede the clause title most of the times may be considered to be the section title; and/or the contract title may be the text which is found at the beginning of the document, or it may be the text with the largest font size in the document.

Note that the specific heuristics described above are exemplary only. Alternative heuristics may also be used in addition to, or in lieu of, the specific techniques described above. For example, in one embodiment, the text string pattern matching may include identifying specific key words (e.g., quantity, payment terms, volume, discount, payment terms, normal discount, special discount, volume discount, concession, rate of discount, etc.) in the contract document to identify types for certain portions of text in the document. In one embodiment, the system may log various text string patterns that are manually classified by the user, based on which the system may generate new or modified versions of the existing heuristics.

In one embodiment of the present invention, the extracted information may be presented to the user in a classified form. As shown in commonly owned U.S. patent application Ser. No. 14/588,591, the entire specification of which is expressly incorporated herein by reference, the structure of the contract that may be extracted or interpreted as described above, may be presented in the form of a tree structure, wherein the method facilitates the user to review the extracted information. It may provide for the user to opportunity to review the classification of text, rectify any misclassified text, assign category to unclassified text and/or the like.

With respect to the storing system to store extracted clauses tagged to the contract category and ID, an item input may be provided in Web form wherein each item searched in an e-procurement system may be depicted on the Web form which may be tagged with the contract ID and further mapped with the purchase control rules. Based on the key word present in the purchase control rules, the relevant clauses may be extracted from the contract for validation. For example, if the control rules include that the quantity is not to exceed 100, then key words like quantity and/or volume may map against the relevant clauses of the contract to fetch the quantity. If the contract clause quantity mentions 50 and the purchase control rules quantity mentions 100, then it is conflicting, and the Web form containing the conflicting details may be flipped and/or configured as an approval form that may be provided to the approver for approval. Similarly, the budgeting module may be activated once the contract module validation is clear, even if there is no contradiction between the purchase control rules and the contract module. If there is a contradiction with the budget module, the Web form containing the conflicting details may be flipped and/or configured to an approval form and may be sent for approval.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that may store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical smayner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

Accordingly, the present invention provides computer based procurement system and method. While specific embodiments are described herein, alternative embodiments will be apparent to person of ordinary skill in the art, in which one or more acts described herein can be modified, performed in different order, or omitted; without departing from the spirit of the invention. Moreover, one or more acts can be added to those described herein. Such alternatives and modifications are included within the scope of the present invention.

What is claimed is:

1. A computer based procurement system, comprising:
a host computer;
a processor unit operably associated with the host computer;
a communication interface selectively operable to access the host computer from a plurality of remote input/output devices so as to manage an element of the procurement system; and
a computer readable medium storing instructions executable by the processor unit to perform the steps of:
receiving a search input for an item to be purchased, wherein the search input is in free form text;
searching one or more electronic catalogs to identify at least one item in the one more catalogs that relates to the search input;
determining a uniform taxonomy code (UTC) associated with the at least one item;
accessing one or more pre-configured purchasing control rules associated with the UTC;
performing an action associated with a purchase order generation based at least upon the one or more pre-configured purchasing control rules; and
searching the one or more electronic catalogs includes matching at least one text term in the search input with a textual description of the items in the one or more electronic catalogs.

2. The system of claim 1, wherein the step of searching the one or more electronic catalogs includes:
determining the UTC for the item being represented by the search input; and
matching the UTC for the item being represented by the search input with UTCs of the items in the one or more electronic catalogs.

3. The system of claim 1, wherein the action includes blocking the generation of the purchase order.

4. The system of claim 1, wherein the action includes retrieval of a purchase order template associated with the UTC from one or more purchase order templates stored in the computer readable medium.

5. The system of claim 1, wherein the one or more electronic catalogs includes at least one web based online catalog.

6. The system of claim 1, wherein the one or more electronic catalogs includes at least one catalog stored in the computer readable medium, wherein a UTC is associated with at least one item in the at least one catalog.

7. The system of claim 6, wherein the computer readable medium stores further instructions executable by the processor unit to perform the steps of:
receiving the at least one catalog to be stored in the computer readable medium;
identifying the UTC for at least one item in the at least one catalog to be stored;
accessing one or more pre-configured catalog import control rules associated with the UTC for the at least one item in the at least one catalog; and
applying the one or more pre-configured catalog import control rules while storing the at least one catalog in the computer readable medium.

8. The system of claim 1, wherein the one or more pre-configured purchasing controls rules include at least one control selected from the group consisting of approved/unapproved vendor, preferred vendor, contract compliance, expert approval, designated purchase department, and budget compliance.

9. A computer based procurement method, comprising the steps of:
providing a host computer;
providing a processor unit operably associated with the host computer;
providing a communication interface selectively operable to access the host computer from a plurality of remote input/output devices so as to manage an element of the procurement system;
providing a computer readable medium storing instructions executable by the processor unit to perform the steps of:
receiving search input for item to be purchased, wherein the search input is in free form text;
searching one or more electronic catalogs to identify at least one item in the one more catalogs that relates to the search input;
determining a uniform taxonomy code (UTC) associated with the at least one item;
accessing one or more pre-configured purchasing control rules associated with the UTC;
performing an action associated with purchase order generation based at least upon the one or more pre-configured purchasing control rules; and
searching the one or more electronic catalogs includes matching at least one text term in the search input with a textual description of the items in the one or more electronic catalogs.

10. The method of claim 9, wherein the step of searching the one or more electronic catalogs includes:
determining the UTC for the item being represented by the search input; and
matching the UTC for the item being represented by the search input with UTCs of the items in the one or more electronic catalogs.

11. The method of claim 9, wherein the action includes blocking the generation of the purchase order.

12. The method of claim 9, wherein the action includes retrieval of a purchase order template associated with the UTC from one or more purchase order templates stored in the computer readable medium.

13. The method of claim 9, wherein the one or more electronic catalogs includes at least one web based online catalog.

14. The method of claim 9, wherein the one or more electronic catalogs includes at least one catalog stored in the computer readable medium, wherein a UTC is associated with at least one item in the at least one catalog.

15. The method of claim 14, further comprising the steps of:
receiving the at least one catalog to be stored in the computer readable medium;
identifying the UTC for at least one item in the at least one catalog;
accessing one or more pre-configured catalog import control rules associated with the UTC for the at least one item in the at least one catalog; and
applying the one or more pre-configured catalog import control rules while storing the at least one catalog in the computer readable medium.

16. The method of claim 9, wherein the one or more pre-configured purchasing controls rules include at least one control selected from the group consisting of approved/unapproved vendor, preferred vendor, contract compliance, expert approval, designated purchase department, and budget compliance.
